(19) United States
(12) Patent Application Publication
(10) Pub. No.: US 2025/0209166 A1
(43) Pub. Date: Jun. 26, 2025

(54) DECENTRALIZED CLOUD STORAGE FOR SUSPICIOUS FILES

(71) Applicant: Saudi Arabian Oil Company, Dhahran (SA)

(72) Inventors: Reem Abdullah Algarawi, Al Jubail (SA); Majed Ali Hakami, Dhahran (SA); Rayan M. Hassanain, Dhahran (SA)

(21) Appl. No.: 18/392,836

(22) Filed: Dec. 21, 2023

(51) Int. Cl. G06F 21/56; G06F 21/60

(52) U.S. Cl. CPC G06F 21/565; G06F 21/602; G06F 2221/034

(57) ABSTRACT

Among other things, techniques are described for detecting one or more suspicious files in at least one of a plurality of hosts associated with an organization; aggregating the one or more suspicious files in a centralized management system; and using a decentralized storage system to query and store the one or more suspicious files using a blockchain based mechanism.

### TECHNICAL FIELD

This description relates to methods and systems for a decentralized cloud storage for suspicious files.

### BACKGROUND

Cloud storage systems can store data on the cloud rather than on local devices. Data from multiple devices can be stored on the cloud. Servers and applications can access the data through shared file system. Centralized cloud storage system store and maintain data in a single location. Centralized cloud storage is susceptible to data breaches.

### SUMMARY

One aspect of the subject matter described in this specification may be embodied in methods that include: detecting one or more suspicious files in at least one of a plurality of hosts associated with an organization; aggregating the one or more suspicious files in a centralized management system; and using a decentralized storage system to query and store the one or more suspicious files using a blockchain based mechanism.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, using a decentralized storage system to query and store the one or more suspicious files using a blockchain based mechanism comprises: receiving, from the centralized management system, the one or more suspicious files.

In some implementations, using a decentralized storage system to query and store the one or more suspicious files using a blockchain based mechanism further comprises: encrypting the one or more suspicious files using an encryption mechanism to generate an encrypted suspicious file for each suspicious file; splitting each encrypted suspicious file into a plurality of subset files; and storing the plurality of subset files in a plurality of decentralized nodes.

In some implementations, the decentralized nodes are located across multiple computing devices.

In some implementations, the multiple computing devices are cloud-based computing devices.

Suspicious files storage, and sharing with other organizations, or entities in the same organization is inherently time consuming. In addition, conventional methods are prone to data integrity issues, and difficult to manage. The methods described in this specification utilize a decentralized cloud storage system for suspicious files by utilizing blockchain technology. Using a decentralized cloud storage system is scalable, easy to use, cost effective, and efficient in comparison to conventional methods.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE DRAWINGS

FIG. 1 shows an example cloud storage system, according to some implementations.

FIG. 2 illustrates an example of storing a suspicious file using a blockchain mechanism, according to some implementations.

FIG. 3 illustrates a flowchart of an example method, according to some implementations.

FIG. 4 illustrates a flowchart of an example method, according to some implementations.

FIG. 5 is a block diagram of an example computer system, according to some implementations.

### DETAILED DESCRIPTION

Suspicious files storage, and sharing with other organizations, or entities in the same organization is inherently time consuming. In addition, conventional methods are prone to data integrity issues, and difficult to manage. Sharing data over the Internet when using centralized cloud storage is susceptible to bad actors (e.g., hackers) and is relatively simple to access and modify. This disclosure describes a decentralized cloud storage system for suspicious files by utilizing blockchain technology. Using a decentralized cloud storage system is scalable, easy to use, cost effective, and computationally efficient in comparison to conventional methods. When using blockchain technology, data is immutable, e.g., it cannot be deleted or modified. Blockchain mechanisms can store identical copies of data across a network of nodes. Whenever a single piece of data is altered in one node, the altered data is immediately recognizable as different from the data in other nodes. This improves data security compared to centralized storage systems. Doing so automatically keeps suspicious files safe from being tampered with in the decentralized cloud storage system. File tampering is more easily detected in a decentralized storage system compared to centralized storage systems.

A security team may have a need to keep suspicious files stored for many reasons. For example, these files can be retrieved from antivirus detections, incidents, breaches, and other security tools. These files coming from various hosts can be hosted on a centralized management system first before they are stored to a decentralized cloud storage system. The idea of having a centralized management system first then a decentralized storage system second facilitates flexibility for an organization.

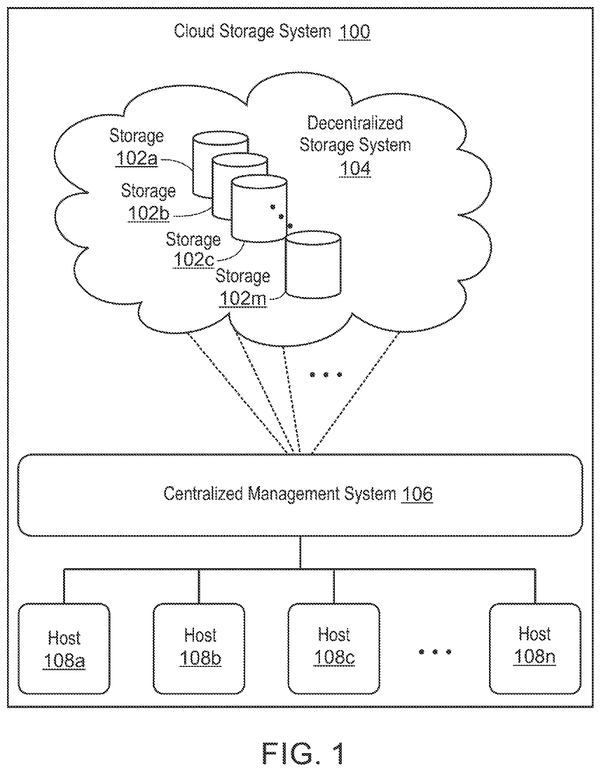

FIG. 1 shows an example cloud storage system 100. The cloud storage system 100 includes a plurality of hosts 108a-n, a centralized management system 106, and a decentralized storage system 104. The plurality of hosts 108a-n can be any type of hardware devices that can permit access to a network, e.g., via a user interface, specialized software, and/or protocol stack. Example hardware devices include computers, personal electronic devices, and multi-functional devices. Each host 108a-n includes clients and servers that can send and receive data, services, and applications.

In some implementations, each host of the plurality of hosts 108a-n can be associated with an organization. The organization can be, for example, a business, a school, a government or any other type of organization.

Each host can potentially include one or more suspicious files that each have an unknown origin, unusual behavior, or association with potentially harmful activities. A suspicious file can contain viruses and other malware that can disrupt, damage, or gain unauthorized access to a host. A suspicious file can be used to alter or delete information that is stored on a host or send information that is stored on one host to other hosts.

In some implementations, a detection module can detect one or more suspicious files from the hosts 108a-n and send the suspicious files to the centralized management system 106. The module can ignore files that are categorized as non-suspicious.

The centralized management system 106 can be any system that allows for data from one or more hosts to be stored in a single location. The centralized management system can aggregate the suspicious files by storing all suspicious files from various organizations in one centralized server. The centralized management system can push the suspicious files to the decentralized storage system 104.

The decentralized storage system 104 can query and store the one or more suspicious files from various organizations using a blockchain based mechanism. The decentralized storage system 104 can receive one or more suspicious files from the centralized management system 106 and encrypt the one or more suspicious files using an encryption mechanism to generate an encrypted suspicious file for each suspicious file. The encryption mechanism can be, for example, an asymmetric-key encryption mechanism.

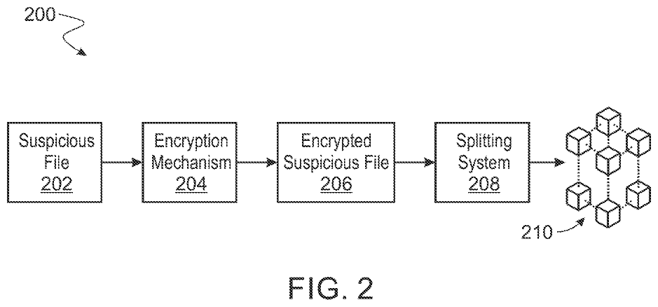

In some implementations, the decentralized management system 104 can split each encrypted suspicious file into subset files and store the subset files in a plurality of decentralized nodes 102a-m. The decentralized management system can generate a specific hash for each subset file. The hash can be an alphanumeric string that is unique to each subset file. The decentralized storage system 104 can distribute the subset files across the decentralized nodes 102a-m. In some examples, the decentralized nodes 102a-m are located across multiple computing devices. The computing devices can be, for example, cloud-based computing devices. Storing and querying a suspicious file will be described in further detail below with regards to FIG. 2.

FIG. 2 illustrates an example 200 of storing a suspicious file using a blockchain mechanism.

An encryption mechanism 204 receives and encrypts a suspicious file 202 to generate an encrypted suspicious file 206. The encrypted suspicious file 206 is a file that has been transformed into a code that is unreadable.

The encryption mechanism can use a cryptographic hash, or hash function, to encrypt the suspicious file 202. A hash function is a one-way cryptographic function i.e., a hash function is not reversible. A hash function generates an alphanumeric value (a “hash value”) based on a text input. A unique input will always result in the same alphanumeric value.

A splitting system 208 splits each encrypted file into a plurality of subset files. Each subset file can be a segment of data from a suspicious file. Each subset file can be represented by a hash value.

Each subset file is stored in a plurality of nodes 210 that are located across multiple computing devices. The nodes 210 can be “blocks”. The blocks are ledgers that can be updates and added to and are filled with permanently recorded data. Whenever a single piece of data is altered in one block, the altered data is immediately recognizable as different from the data in other blocks. This improves data security compared to centralized storage systems.

The suspicious files can be stored as a repository for future use. A security team or a security software can use the repository to determine if a new suspicious file has been received in a previous incident. Additionally, the repository can maintain the history of each suspicious file.

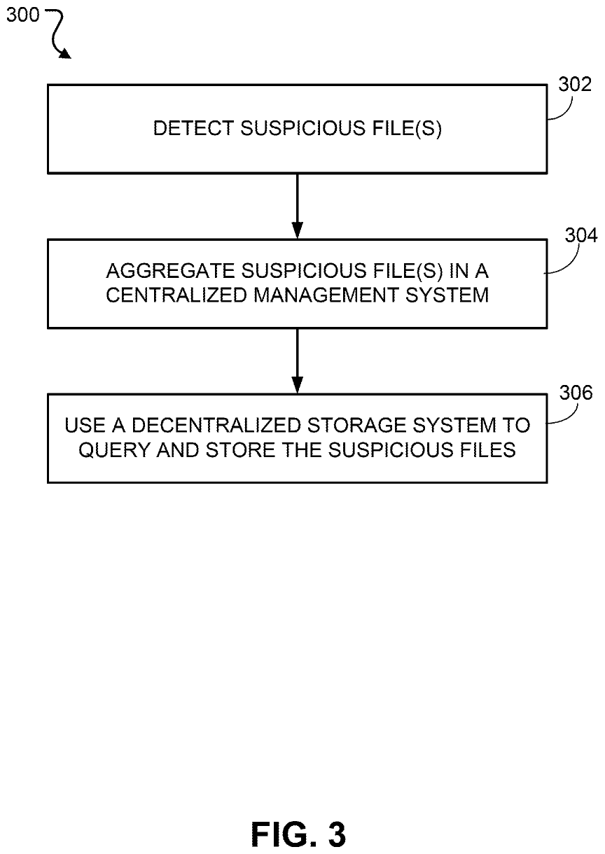

FIG. 3 illustrates a flowchart of an example method 300, according to some implementations. For clarity of presentation, the description that follows generally describes method 300 in the context of the other figures in this description. For example, method 300 can be performed by the cloud storage system 100 of FIG. 1. It will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

The system can detect one or more suspicious files in at least one of a plurality of hosts associated with an organization (step 302). A suspicious file can contain viruses and other malware that can disrupt, damage, or gain unauthorized access to a host. A suspicious file can be used to alter or delete information that is stored on a host or send information that is stored on one host to other hosts.

The system can aggregate the one or more suspicious files in a centralized management system (step 304). The centralized management system can aggregate the suspicious files by storing all suspicious files from various organizations in one place. The centralized management system can push the suspicious files to a decentralized storage system.

The system can use the decentralized storage system to query and store the one or more suspicious files using a blockchain based mechanism (step 306).

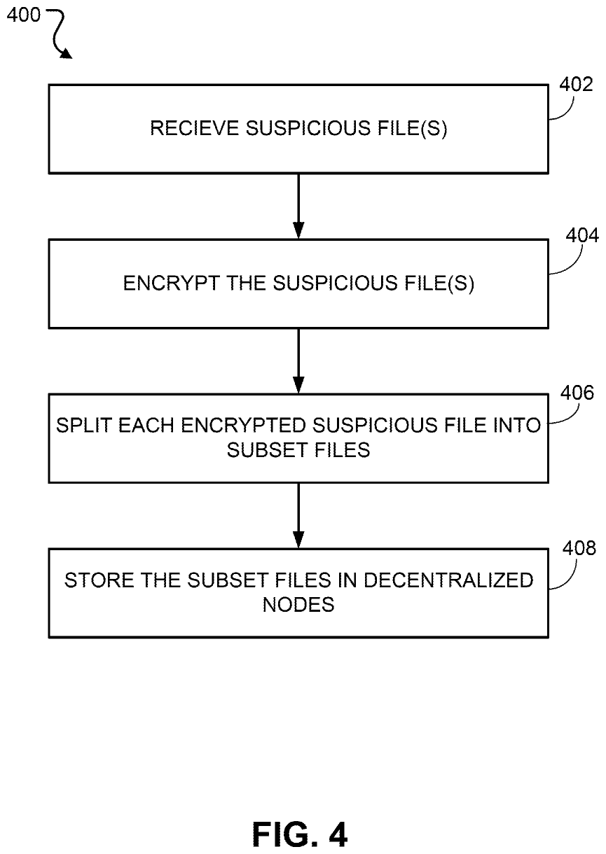

FIG. 4 illustrates a flowchart of an example method 400, according to some implementations. For clarity of presentation, the description that follows generally describes method 400 in the context of the other figures in this description. For example, method 400 can be performed by the decentralized storage system 104 of FIG. 1. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

The system can receive one or more suspicious files from a centralized management system (step 402). Each suspicious file can be associated with one of a plurality of organizations.

The system can encrypt the one or more suspicious files using an encryption mechanism to generate an encrypted suspicious file for each suspicious file (step 404).

The system can split each encrypted suspicious file into a plurality of subset files (step 406). The subset files can represent smaller segments of data stored in each suspicious file.

The system can store the plurality of subset files in a plurality of decentralized nodes (step 408). The decentralized nodes can be located across multiple computing devices. The computing devices can be, for example, cloud-based computing devices. Each node can have an identical copy of each subset file.

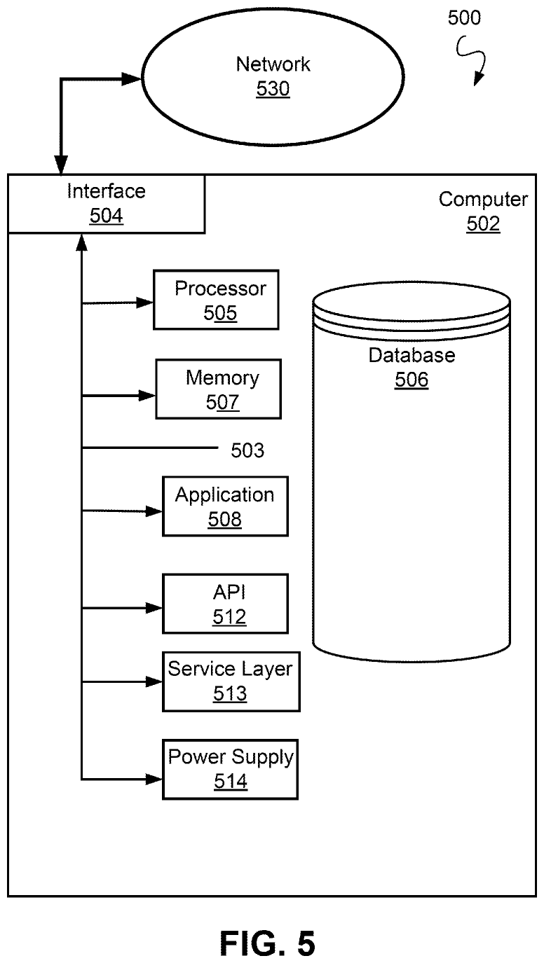

FIG. 5 is a block diagram of an example computer system 500 that can be used to provide computational functionalities associated with described algorithms, methods, functions, processes, flows, and procedures, according to some implementations of the present disclosure. In some implementations, the cloud storage system 100 can be the computer system 500, include the computer system 500, or the cloud storage system 100 can communicate with the computer system 500.

The illustrated computer 502 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 502 can include a Smart Embedded Management Agent (SEMA), such as a built-in ADLINK SEMA 2.2, and a video sync technology, such as Quick Sync Video technology supported by ADLINK MSDK+. In some examples, the computer 502 can include the MXE-5400 Series processor-based fanless embedded computer by ADLINK, though the computer 502 can take other forms or include other components.

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both), over the system bus. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs 512.

The service layer 513 can provide software services to the computer 502 and other components (whether illustrated or not) that are communicably coupled to the computer 502. The functionality of the computer 502 can be accessible for all service consumers using this service layer 513. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 can include an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and manipulate data to perform the operations of the computer 502, including operations using algorithms, methods, functions, processes, flows, and procedures as described in the present disclosure.

The computer 502 can also include a database 506 that can hold data for the computer 502 and other components connected to the network 530 (whether illustrated or not). For example, database 506 can be an in-memory, conventional, or a database storing data consistent with the present disclosure. In some implementations, the database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

An application 508 can be an algorithmic software engine providing functionality according to particular needs, desires, or particular implementations of the computer 502 and the described functionality. For example, an application 508 can serve as one or more components, modules, or applications 508. Multiple applications 508 can be implemented on the computer 502. Each application 508 can be internal or external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system including computer 502, with each computer 502 communicating over network 530. Further, the terms “client,” “user,” and other appropriate terminology can be used interchangeably without departing from the scope of the present disclosure. Moreover, the present disclosure contemplates that many users can use one computer 502 and one user can use multiple computers 502.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer using a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A method comprising:
detecting one or more suspicious files in at least one of a plurality of hosts associated with an organization;
aggregating the one or more suspicious files in a centralized management system; and
using a decentralized storage system to query and store the one or more suspicious files using a blockchain based mechanism.

2. The method of claim 1, wherein using a decentralized storage system to query and store the one or more suspicious files using a blockchain based mechanism comprises:
receiving, from the centralized management system, the one or more suspicious files.

3. The method of claim 2, wherein using a decentralized storage system to query and store the one or more suspicious files using a blockchain based mechanism further comprises:
encrypting the one or more suspicious files using an encryption mechanism to generate an encrypted suspicious file for each suspicious file;
splitting each encrypted suspicious file into a plurality of subset files; and
storing the plurality of subset files in a plurality of decentralized nodes.

4. The method of claim 1, wherein the decentralized nodes are located across multiple computing devices.

5. The method of claim 4, wherein the multiple computing devices are cloud-based computing devices.

6. A system comprising:
one or more processors configured to perform operations comprising:
detecting one or more suspicious files in at least one of a plurality of hosts associated with an organization;
aggregating the one or more suspicious files in a centralized management system; and
using a decentralized storage system to query and store the one or more suspicious files using a blockchain based mechanism.

7. The system of claim 6, wherein using a decentralized storage system to query and store the one or more suspicious files using a blockchain based mechanism comprises:
receiving, from the centralized management system, the one or more suspicious files.

8. The system of claim 7, wherein using a decentralized storage system to query and store the one or more suspicious files using a blockchain based mechanism further comprises:
encrypting the one or more suspicious files using an encryption mechanism to generate an encrypted suspicious file for each suspicious file;
splitting each encrypted suspicious file into a plurality of subset files; and
storing the plurality of subset files in a plurality of decentralized nodes.

9. The system of claim 6, wherein the decentralized nodes are located across multiple computing devices.

10. The system of claim 9, wherein the multiple computing devices are cloud-based computing devices.

11. A non-transitory computer storage medium encoded with instructions that, when executed by one or more computers, cause the one or more computers to perform operations for managing a gas production system, the operations comprising: one or more processors configured to perform operations comprising:
detecting one or more suspicious files in at least one of a plurality of hosts associated with an organization;
aggregating the one or more suspicious files in a centralized management system; and
using a decentralized storage system to query and store the one or more suspicious files using a blockchain based mechanism.

12. The non-transitory computer storage medium of claim 11, wherein using a decentralized storage system to query and store the one or more suspicious files using a blockchain based mechanism comprises: receiving, from the centralized management system, the one or more suspicious files.

13. The non-transitory computer storage medium of claim 12, wherein using a decentralized storage system to query and store the one or more suspicious files using a blockchain based mechanism further comprises:
encrypting the one or more suspicious files using an encryption mechanism to generate an encrypted suspicious file for each suspicious file;
splitting each encrypted suspicious file into a plurality of subset files; and storing the plurality of subset files in a plurality of decentralized nodes.

14. The non-transitory computer storage medium of claim 11, wherein the decentralized nodes are located across multiple computing devices.

15. The non-transitory computer storage medium of claim 14, wherein the multiple computing devices are cloud-based computing devices.
